(19) United States
(12) Patent Application Publication
(10) Pub. No.: US 2004/0118779 A1
(43) Pub. Date: Jun. 24, 2004

(54) Unitary water filter assembly for removal of chemical and microbiological contaminants

(76) Inventors: James Rulon Young Rawson, Clifton Park, NY (US); Daniel Ryan Capelle, Corydon, IN (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/328,597

(22) Filed: Dec. 23, 2002

(51) Int. Cl. B01D 61/00

(52) U.S. Cl. 210/650; 210/669; 210/315; 210/317; 210/266

(57) ABSTRACT

A unitary water filter assembly and method for removing all microbiological and multiple types of chemical contaminants from water used in an appliance for human consumption are provided. The filter assembly includes a first filter stage fluidly coupled to receive influent water for filtering chemical contaminants therein. A second filter stage is fluidly coupled to the first filter stage for filtering microbiological organisms therein. The filter assembly allows removal of all microorganisms such as cysts, bacteria, bacterial spores and viruses, from the drinking water. The filter assembly may also be configured to remove chemicals, such as chlorine, including associated taste and odor with such chemicals, particulates, and metal contaminants from drinking water. The filter assembly may be further configured to remove volatile organic compounds (VOCs), and other organic and inorganic contaminants from drinking water.

### BACKGROUND OF THE INVENTION

Water filters, such as in-line after market water filters for refrigerators, filters pre-installed in a refrigerator unit and under-the-counter water filters, have been able to remove many chemical contaminants, and, may have been able to remove some relatively large microbiological organisms, such as cysts (i.e., protozoa such as Cryptosporidium and Giardia) from drinking water. These filters, however, have not been able to remove from the drinking water smaller microbiological organisms, e.g., bacteria, bacterial spores and/or viruses.

Separate and relatively bulky and complex treatment units specially configured (e.g., using ultraviolet radiation) for the treatment of the relatively small microbiological forms have been required to meet these microbiological treatment needs. Unfortunately, the addition of such a specialized separate treatment unit to an appliance would lead to substantial incremental costs, assuming that the manufacturer of the appliance is even able to find the appropriate space for installing any such separate treatment unit.

In view of the foregoing considerations, it would be desirable to provide a microbiological water purifier filter that may be affordably and compactly manufactured to provide a unitary filter assembly for reliable and cost-effective removal of all forms of microbiological organisms, including cysts, bacteria, bacterial spores and/or viruses as well as removal of chemical contaminants, such as chlorine and other contaminants. It would be further desirable to provide a microbiological water purifier filter that without the use of a drain and/or electrical power is able to remove such microbiological organisms.

### BRIEF SUMMARY OF THE INVENTION

Generally, the present invention fulfills the foregoing needs by providing in one aspect thereof, a unitary water filter assembly including a first filter stage fluidly coupled to receive influent water for filtering chemical contaminants therein, and a second filter stage fluidly coupled to the first filter stage for filtering microbiological organisms therein, such as cysts, bacteria, bacteria spores and viruses.

In another aspect thereof, the present invention further fulfills the foregoing needs by providing a method for removing contaminants from water dispensed by an appliance for consumption, e.g., human, pet consumption, etc. The method allows fluidly coupling a first filter stage to receive influent water for filtering chemical contaminants therein. The method further allows fluidly coupling a second filter stage to the first filter stage for filtering microbiological forms therein, such as cysts, bacteria, bacteria spores and viruses.

### BRIEF DESCRIPTION OF THE DRAWINGS

The features and advantages of the present invention will become apparent from the following detailed description of the invention when read with the accompanying drawings in which:

FIG. 1 is a cross-sectional view of one exemplary embodiment of a water filter assembly, including concentrically disposed first and second filter stages for removing chemical and microbiological contaminants, respectively.

FIG. 2 shows exemplary water flow paths within the filter assembly of FIG. 1.

FIG. 3 is a cross-sectional view of another exemplary embodiment of a water filter assembly, including serially disposed first and second filter stages for removing chemical and microbiological contaminants, respectively.

FIG. 4 shows exemplary water flow paths within the filter assembly of FIG. 3.

FIG. 5 is a cross-sectional view of a coupling assembly that may be used by either of the water filter assemblies of FIGS. 1 and 3 for avoiding or reducing the possibility of cross-contamination between influent and effluent water passing through the filter assembly.

FIG. 6 is a side view of a shell containing ultrafiltration membranes in the form of hollow fiber filters for removal of all forms of microbiological organisms.

FIG. 7 is an expanded view of exemplary components used by a water filter assembly embodying aspects of the present invention.

### DETAILED DESCRIPTION OF THE INVENTION

The inventors of the present invention have innovatively recognized a relatively low-cost and compact unitary water filter assembly for reliable removal of various microbiological organisms, such as cysts, bacteria, bacterial spores and/or viruses as well as removal of chemical contaminants.

In one exemplary embodiment, such as illustrated in FIG. 1, a filter assembly 10 comprises an outer canister 12 configured to enclose a sleeve 14 made of a suitable polymer, such as polypropylene melt blown or wound media, marketed in commerce under the trade name/designation polyspun media. Sleeve 14 comprises a first filtering path configured to remove particulates, e.g., colloidal particulate material. Sleeve 14 encloses a cartridge 16 that constitutes a first filtering stage configured to remove contaminants, such as oxidizing chemicals, e.g., chlorine, including removal of taste and odor associated with such oxidizing chemicals, and other chemical contaminants. A second filter stage is concentrically disposed relative to the first stage and, in operation, is fluidly coupled to the first stage to receive filtered water that passes from the first stage to remove any microbiological organisms that may be present in the filtered water output from the first filter stage, as described in greater detail below. Neither of the filter stages requires a drain or electrical power for operation. In one exemplary embodiment, the unitary assembly may be considered disposable at the end of its rated filtering capacity.

In one exemplary embodiment, cartridge 16 comprises a suitable adsorbent, such as activated carbon, calcined clay, adsorption resins (especially carbonaceous type, e.g., Ambersorb 563), silica gels, alumina, kaolinite and zeolites, nanoparticles and any combination thereof. In one exemplary embodiment, activated carbon is used because of the high adsorption capacity and relatively low cost of activated carbon. In one exemplary embodiment, a sufficiently large amount of carbon could be added to enable the cartridge to remove a spectrum of organic compounds, such as volatile organic compounds (VOCs) and other organic compounds that might contaminate drinking water. A suitable metal-adsorbent material, such as a metal-adsorbent resin, can be optionally incorporated in the cartridge to remove metal contaminants from the water, such as lead and/or mercury and other such contaminants.

A shell 18, such as may be made of plastic, in one exemplary embodiment comprises a mesh opening or plurality of slots, holes or openings to permit flow of water through it. Shell 18 may be configured to define an inner core for receiving ultrafiltration membrane filters 20. In one exemplary embodiment, the ultrafiltration membrane filters comprise membranes, such as hollow filter membranes or spiral wound flat sheet membranes with pores of a size appropriate for removing all microbiological contaminants. In one exemplary embodiment, the pore size may be a minimum of approximately 0.025 microns (25 nanometers) in size. It will be understood that the foregoing example is just that, an example, and should not be construed as a limitation of the present invention. In general, an ultrafiltration membrane functions as a molecular sieve. It separates particles and molecules on the basis of size by passing a solution through an infinitesimally fine filter. This ultrafilter comprises a relatively tough, thin, selectively permeable membrane that retains most macromolecules above a certain size, including colloids, microorganisms and pyrogens. For readers desirous of additional background information regarding the physical principles involved in the filtering action provided by ultrafiltartion membranes, reference is made to the Report issued by the United States Environmental Protection Agency, EPA 815-C-01-001 (April 2001), titled “Low-Pressure Membrane Filtration For Pathogen Removal: Application, Implementation, And Regulatory Issues,” which report is incorporated herein by reference.

In one exemplary embodiment, the ultrafiltration membranes may be configured to block passage to particles and/or microbiological organisms greater than approximately 0.025 microns (25 nanometers) in diameter. By way of example, such microbiological organisms may, include cysts (protozoa such as Cryptosporidium, Giardia, Toxoplasma, etc., and parasites such as Entamoeba, etc.), bacteria, bacterial spores and viruses. Examples of ultrafiltration membranes suitable for purposes of the present invention include those manufactured by and commercially available from Millipore, Pall, Zenon, Norit, etc. It will be understood that the present invention is not limited to ultrafiltration membranes from such suppliers, since ultrafiltration membranes from other suppliers can be readily used for purposes of the present invention.

As shown in FIG. 1, in this exemplary embodiment, shell 18 and hollow fiber filters 20 constitute the second filter stage which is concentrically disposed relative to the first filter stage (e.g., adsorbent cartridge 16) for removing any forms of microbiological organisms, including cysts, bacteria, bacterial spores and viruses that may be received from the water that passes through the first filter stage.

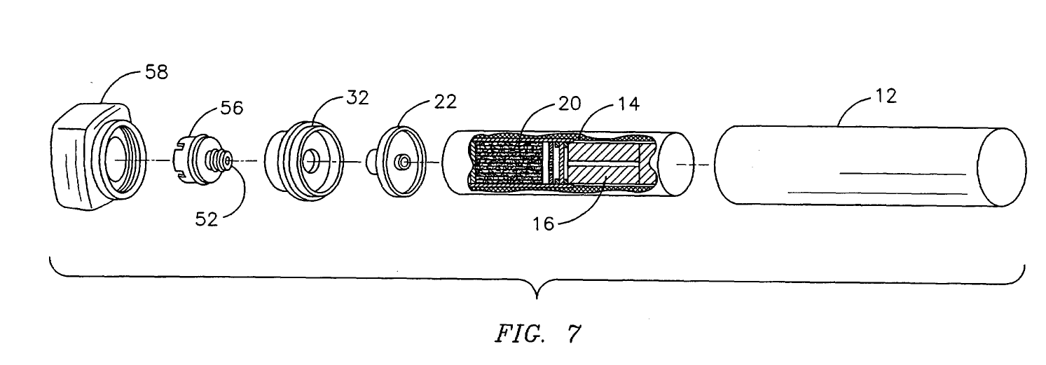

As best shown in FIG. 6, ultrafiltration membranes in the form of hollow fiber filters may be looped at one end of shell 18 (e.g., shell end 19) so that the respective ends of each fiber with corresponding openings are held in place by an affixing lid 22, e.g., adhesive, plastisal, or other sealable media disposed at the opposite end (e.g., shell end 21) of shell 18. In one exemplary embodiment, affixing lid 22 provides an adhesive dam or structure for receiving a suitable adhesive, (e.g., glue) for affixing the respective ends of the fiber filters.

A layer or wrap 24, (FIG. 1) such as made of polyspun media or other suitable filter element, may be interposed in the annular space defined between adsorption cartridge 16 and shell 18 to block passage to any particulates, such as carbon particulates, that may exit from the cartridge during initial use of the cartridge. This layer helps to extend the life of the ultrafiltration membranes.

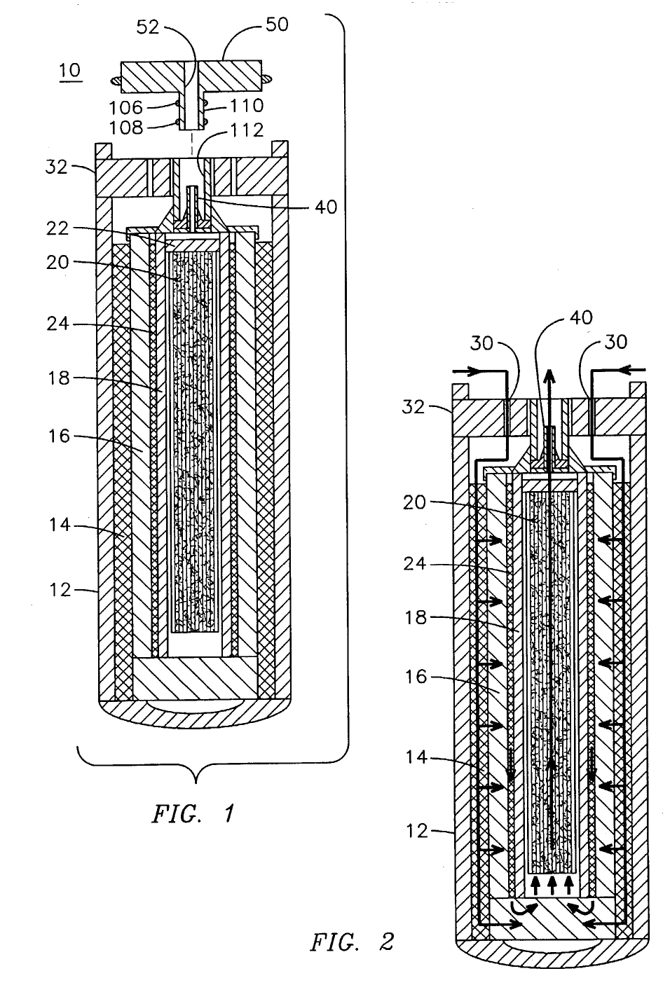

In operation, as shown in FIG. 2, and represented by the various arrows indicative of exemplary water flow within filter assembly 10, influent water may enter the filter assembly through an inlet port 30 disposed through a sealing cap 32 of canister 12 and travel through sleeve 14 and into the first filter stage, e.g., adsorbent cartridge 16. As will be now appreciated by those skilled in the art, sleeve 14 provides a pre-filtering process to remove colloidal particulate materials that may be present in the influent water to prolong the operational life of the adsorption cartridge. After the filtering action provided by adsorption cartridge 16, water would then flow through wrap 24 and into shell 18, e.g., filled with ultrafiltration membranes in the form of hollow fiber filters, through a plurality of openings at the base or on the sides of the shell. Water would then pass through the bundle of hollow fiber filters from the exterior of each hollow fiber filter to the respective interior of the hollow fiber filter. As suggested above, the hollow fiber filters are configured to remove all microbiological organisms, such as cysts, bacteria, bacterial spores and viruses from the water. In one exemplary embodiment, water would travel upwardly along the inside of each hollow fiber filter and would exit through the openings at the respective ends affixed to affixing lid 22.

A needle valve 40 may be provided to direct the flow of the purified effluent water through a respective interface manifold 50. The needle valve may serve at least two purposes. One purpose would be to provide a user-friendly and secure interface with a passageway 52 in manifold 50 for passing effluent water. Another purpose of the needle valve is that one may configure the needle valve as a flow restrictor for the filter assembly. As will be appreciated by those skilled in the art, such a flow restrictor may be used to achieve enhanced adsorption of contaminants passing through the adsorption cartridge since the adsorption ability of the cartridge may be time dependent. For example, increased contact time with the carbon may facilitate adsorption of certain contaminants that may be present in the water. Thus, by appropriately restricting the flow of effluent water exiting from the filter assembly, in essence one may appropriately set the contact time for water that passes through the adsorption cartridge. It will be appreciated that such a flow restrictor may be directly built into the filter assembly (e.g., the needle valve) or the flow restrictor may be provided external to the filter assembly. For example, in a refrigerator the restrictor could be coupled in an outlet for a water dispenser therein. In one exemplary embodiment, it may be preferred to have the flow restrictor integrated with the filter assembly so as to provide a stand-alone filter. This would allow for a more universal filter interface because one would be able to provide any appropriate flow rate to meet any given requirements for removal of chemical contaminants through the adsorption cartridge.

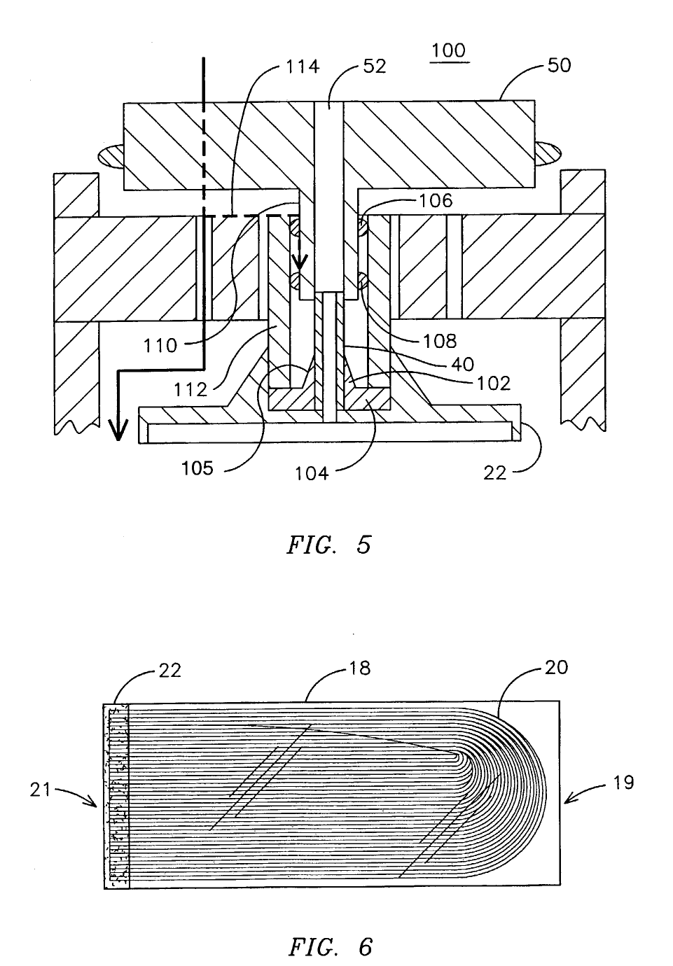

As will be appreciated by those skilled in the art, another aspect of the present invention provides a seal assembly 100 (FIG. 5) configured to avoid cross-contamination between influent water that may comprise microbiological organisms and the purified effluent water. In one exemplary embodiment, a tapered gasket 102 is situated around needle valve 40. Gasket 102 provides at least two sealing areas: 1) For example, gasket 102 comprises a base 104 configured to provide a sealing action between a manifold section, e.g., the bottom section of manifold 50, and affixing lid 22 and 2) gasket 102 further comprises a tapered surface 105 to provide a sealing action relative to the passageway 52 in manifold 50 that receives the needle valve 40 for passing effluent water. In one exemplary embodiment, manifold 50 includes a pair of O-rings 106 and 108 configured to provide respective sealing actions between engaging male and female couplers 110 and 112, respectively. In one exemplary embodiment, O-rings 106 and 108 would prevent leakage of influent water along a path represented by dashed line 114. It is believed that, in the unlikely event that each of O-rings 106 and 108 were to fail to provide their respective sealing function, gasket 102 would provide a backup sealing action to prevent passage of influent water that could otherwise cross-contaminate the effluent water from the filter assembly.

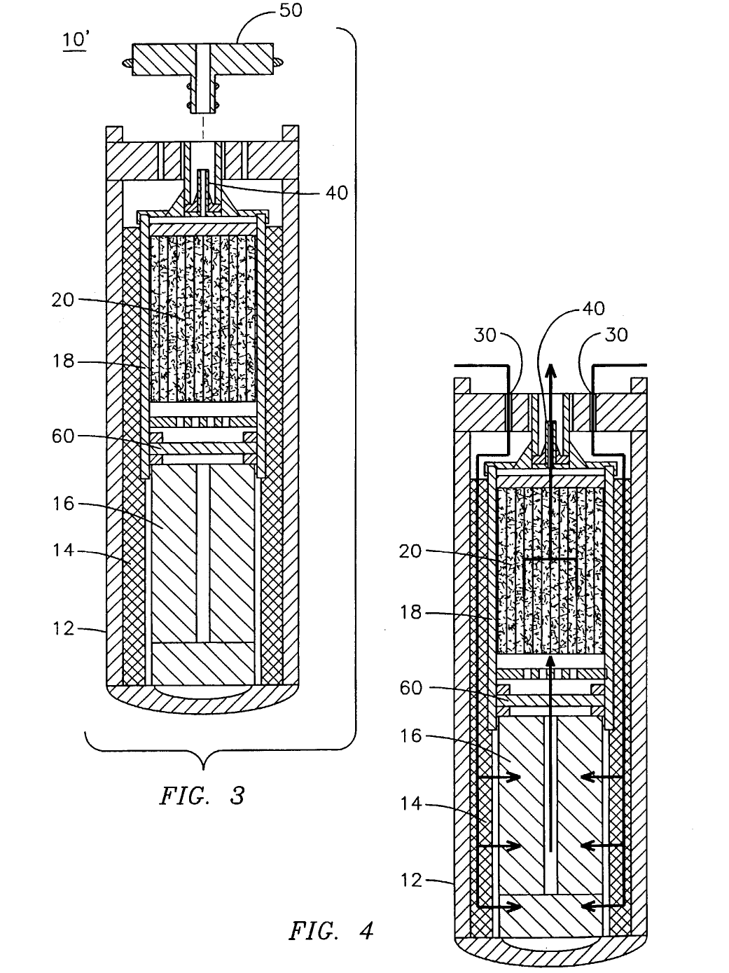

In another exemplary embodiment, as illustrated in FIG. 3, a filter assembly 10′ comprises a second type of filter stage (e.g., the microbiological filter comprising ultrafiltration membranes in the form of hollow fiber filters 20 in shell 18) that is serially disposed (e.g., downstream) relative to the first stage (e.g., adsorbent cartridge 16). In operation, the second filter stage is fluidly coupled to the first stage to receive filtered water from that first stage to remove any and all microbiological organisms that may be present in the water output from the first filter stage. In this case, a pad 60, such as a circular pad made of polyspun media or other suitable filter element, may be interposed between adsorption cartridge 16 and shell 18 to block passage to any particulates, such as carbon particulates, that may exit from the cartridge during initial use of the cartridge. As suggested above, sleeve 14 may be used to remove colloidal particulate material from the influent water prior to adsorption cartridge 14. The various arrows shown in FIG. 4 represent exemplary water flow within filter assembly 10′.

FIG. 7 is an expanded view of exemplary components used by a water filter assembly embodying aspects of the invention. This view should facilitate visualizing the relative simplicity of assemblage of some of the relatively few components of a unitary and compact water filter assembly that advantageously provides both removal of chemical and microbiological forms, in accordance with aspects of the present invention. As shown in FIG. 7, outer canister 12 may be configured to receive the various components that comprise the first and second filter stages, such as cartridge 16, ultrafiltration membranes 20, sleeve 14, etc., as described above. FIG. 7 further shows affixing lid 22 for affixing the ultrafiltration membranes within the inner core of cartridge 16. Sealing cap 32 allows to seal canister 12 and further allows interface with an adaptor plug 56 that, for example, threadingly mates with a tubing head 58 that allows interfacing with suitable water-conducting lines or tubing in the appliance, such as lines or tubing connected to a water dispenser and/or an ice maker of a refrigerator appliance.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A unitary water filter assembly comprising:
a first filter stage fluidly coupled to receive influent water for filtering chemical contaminants therein; and
a second filter stage fluidly coupled to the first filter stage for filtering microbiological organisms therein, wherein the microbiological organisms are selected from the group consisting of cysts, bacteria, bacterial spores, viruses and any combination thereof.

2. The water filter assembly of claim 1 wherein the first filter stage comprises an adsorbent cartridge.

3. The water filter assembly of claim 2 wherein the adsorbent in the cartridge is selected from the group consisting of activated carbon, calcined clay, kaolinite, adsorption resins, carbonaceous type resins, silica gels, alumina, zeolites, nanoparticles and any combination thereof.

4. The water filter assembly of claim 1 wherein the second filter stage comprises an ultrafiltration membrane comprising a bundle of hollow fiber filters.

5. The water filter assembly of claim 1 wherein the second filter stage comprises an ultrafiltration membrane comprising spiral wound flat sheet membranes.

6. The water filter assembly of claim 1 wherein the second filter stage is concentrically disposed relative to the first filter stage to receive filtered water output therefrom.

7. The water filter assembly of claim 6 further comprising a wrap of polypropylene media interposed between an adsorption cartridge and an ultrafiltration membrane comprising a bundle of hollow fiber filters to remove carbon particulates, wherein the adsorption cartridge comprises the first filter stage and the ultrafiltration membrane in the form of hollow fiber filters comprises the second filter stage.

8. The water filter assembly of claim 1 further comprising a sleeve of polypropylene media interposed between an outer canister and an adsorption cartridge to remove colloidal particulate material, wherein the adsorption cartridge comprises the first filter stage.

9. The water filter assembly of claim 1 wherein the second filter stage is serially disposed downstream relative to the first filter stage.

10. The water filter assembly of claim 9 further comprising a pad of polypropylene media interposed between an adsorption cartridge and an ultrafiltration membrane comprising a bundle of hollow fiber filters to remove carbon particulates, wherein the adsorption cartridge comprises the first filter stage and the ultrafiltration membrane in the form of hollow fiber filters comprises the second filter stage.

11. The water filter assembly of claim 9 further comprising a sleeve of polypropylene media to remove colloidal particulate material from the influent water prior to an adsorption cartridge, wherein the adsorption cartridge comprises the first filter stage.

12. The water filter assembly of claim 1 further comprising a sealing assembly configured to avoid cross-contamination between influent and effluent water passing through the filter assembly.

13. The water filter assembly of claim 12 further comprising a needle valve, wherein the needle valve is configured to provide a predefined amount of flow restriction to effluent water passing therethrough.

14. The water filter assembly of claim 13 further comprising an affixing lid at one end of a shell containing a bundle of hollow fiber filters, the lid configured to affix respective open ends of the bundle of hollow fiber filters, wherein the open ends provide passage to water that enters through the exterior of the hollow fiber filters, travels through the hollow interior and exits free from the microbiological organisms.

15. The water filter assembly of claim 12 wherein the seal assembly comprises a gasket seated around the needle valve, said gasket comprising a base for sealing passage of water between the affixing lid and an external interface manifold.

16. The water filter assembly of claim 15 wherein the gasket further comprises a tapered surface for sealing passage of water relative to a passageway defined in the manifold for receiving the needle valve.

17. A method for removing contaminants from water dispensed by an appliance, the method comprising:
fluidly coupling a first filter stage to receive influent water for filtering chemical contaminants therein; and
fluidly coupling a second filter stage to the first filter stage for filtering microbiological organisms therein, wherein the microbiological organisms are selected from the group consisting of cysts, bacteria, bacterial spores, viruses and any combination thereof.

18. The method of claim 17 further comprising configuring the first filter stage as a cartridge to adsorb the chemical contaminants therein.

19. The method of claim 18 wherein adsorbent material in the cartridge is selected from the group consisting of activated carbon, calcined clay, kaolinite, adsorption resins, carbonaceous type resins, silica gels, alumina, zeolites, nanoparticles and any combination thereof.

20. The method of claim 17 further comprising configuring an ultrafiltration membrane in the form of a bundle of hollow fiber filters, the hollow fiber filters constituting the second filter stage.

21. The method of claim 17 further comprising configuring an ultrafiltration membrane in the form of spiral wound flat sheet membranes, the flat sheet membranes constituting the second filter stage.

22. The method of claim 17 further comprising concentrically disposing the second filter stage relative to the first filter stage to receive filtered water output therefrom.

23. The method of claim 22 further comprising interposing a wrap of polypropylene media between an adsorption cartridge and an ultrafiltration membrane comprising a bundle of hollow fiber filters to remove carbon particulates, wherein the adsorption cartridge comprises the first filter stage and the ultrafiltration membrane in the form of a bundle of hollow fiber filters comprises the second filter stage.

24. The method of claim 17 further comprising interposing a sleeve of polypropylene media between an outer canister and an adsorption cartridge to remove colloidal particulate material, wherein the adsorption cartridge comprises the first filter stage.

25. The method of claim 17 further comprising serially disposing the second filter stage downstream relative to the first filter stage.

26. The method of claim 25 further comprising interposing a pad of polypropylene media between an adsorption cartridge and an ultrafiltration membrane comprising a bundle of hollow fiber filters to remove carbon particulates, wherein the adsorption cartridge comprises the first filter stage and the ultrafiltration membrane in the form of hollow fiber filters comprises the second filter stage.

27. The method of claim 25 further comprising providing a sleeve of polypropylene medium to remove colloidal particulate material from the influent water prior to an adsorption cartridge, wherein the adsorption cartridge comprises the first filter stage.

28. The method of claim 17 further comprising configuring a sealing assembly to avoid cross-contamination between influent and effluent water passing through the filter assembly.

29. The method of claim 28 further comprising providing a predefined amount of flow restriction to effluent water passing through a needle valve.

30. The method of claim 29 further comprising affixing respective open ends of a bundle of hollow fiber filters to an affixing lid, wherein the open ends provide passage to water entering through the exterior of the hollow fiber filters, traveling through the hollow interior and exiting free from the microbiological organisms.

31. The method of claim 30 wherein the configuring of the seal assembly comprises seating a gasket around the needle valve and providing a base for sealing passage of water between the affixing lid and a corresponding section of an interface manifold.

32. The method of claim 31 further comprising tapering a surface of the seal gasket for sealing passage of water relative to a passageway defined in the manifold for receiving the needle valve.
